(19) United States
(12) Patent Application Publication
(10) Pub. No.: US 2018/0301956 A1
(43) Pub. Date: Oct. 18, 2018

(54) Electromagnet SRE Plus

(71) Applicant: Robert Oneil Davis, Windsor, VA (US)

(72) Inventor: Robert Oneil Davis, Windsor, VA (US)

(21) Appl. No.: 15/486,206

(22) Filed: Apr. 12, 2017

(51) Int. Cl. H02K 7/02

(52) U.S. Cl. CPC H02K 7/02; H02K 53/00

(57) ABSTRACT

The novelty here is that this SRE Electromagnet stand-alone unit (does not require an external source of energy to be set in motion—for continuous operation, or for continually producing surplus energy)—utilizing the property of inertia—this invention makes this possible by the displacement of resistant power. By utilizing centrifugal force of One or more weighted spin-wheels—a (Single deep grove ball barring casings on each end)—a reduction gearbox, or sprockets. (Capable of charging external batteries while also adequately recharging its own internal battery's energy)—without the need of an outside external source of energy or fuel. The primary object novelty of the SRE invention is (self-reliant)—(self-regenerating energy) for remote areas, home lights, electric cars, boats, est.

Electromagnet SRE unit uses a balanced high speed rotating dead-weight spin-wheels with Permanent magnets or superconductive (EDS) Material magnets mounted, or installed on or with-in the spin-wheels. Electromagnet SRE uses several electromagnets enclosed within or positioned on the towel base enclosed or surrounding the spin-wheel and its permanent magnets or (EDS). Each electromagnet assembly attracts or repels by quickly turning on or off as the spin-wheels rotates. SRE spin-wheels dead-weight utilizes the centrifugal force of Inertia. Electromagnet SRE uses a delayed clutch rpm gear on each spin-wheel shaft that delays the load until each Spin-Wheel will reach a suitable higher RPM.

The spin-wheels system expounds over its generator's resistant by using centrifugal force, dead weight and a secondary energy system or dc batteries to power its mounted electromagnets. While utilizing each spin-wheel's higher rotating speed of centrifugal force Inertia to minimize the generator and components drag resistant's reducing the energy drain on all batteries.

First: SRE Electromagnet system assembly uses and utilizes the (EMS) pulse system to Repel or Attract permanent Magnets or the Electrodynamic (EDS) Superconductive magnet Materials. SRE Electromagnets assembly creates around it's coiled wires an sends out a north or south pole magnet energy field to south or north pole magnetic field—within the SRE Electromagnets field boxes that attract or repel against the permanent magnets, or the Electrodynamic magnet Materials.

Permanent magnets or superconductive (EDS) Material magnets are installed on or with-in the spin-wheels itself that repels, or Attract the South and or North pole coils of Electromagnets.

Second: (Electromagnet SRE) may use one or several Spin-Wheels which are larger, smaller, heavier or lighter than the spin-wheel preceding it to minimize start-up amps. Electromagnets SRE Utilizing heavy dead-weight spin-wheels poundage, and higher rpm speed rotation in excess of about 1 or more times the rpm speed or dead-weight lbs. of its generator's and other components lbs. resistant's.

Third: Electromagnets SRE spin-wheels may use a balance centrifugal force of 1 or more plus times the rpm speed of the generator's compared to the generator's rpm drag lb. resistant or rotation-applications.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

“Not Applicable”

### STATEMENT REGARDING PRIOR DISCLOSURES BY THE INVENTOR OR A JOINT INVENTOR

“Not Applicable”

### BACKGROUND OF THE INVENTION

The Alternative Energy—Electromagnet SRE Energy system generator unit is a Stand-alone system that will recharge the batteries without external power. Electromagnets SRE generates electrical energy by torque from Inertia centrifugal force, and Electromagnet to permanent magnet system or to a Electrodynamic (EDS) superconductive magnet material mounted on the spin-wheels in place of the Permanent Magnets in which the EDS material is cooled to extremely low temperature but attracts or repels the Electromagnet better. The Electromagnet SRE system is set-up and positioned the same way but using Electrodynamic (EDS) superconductive material in place of the permanent magnets. Once set in motion the unit will generate surplus energy much more than is required for self-sustaining itself. This system may also use a high RPM, low amp electric drive motor (not shown) for start-up purposes an A delayed clutch rpm gear on each spin-wheel shaft, a rpm reduction gearbox or sprockets, a power directional splitter, and a dc turbine generator.

### CITED ART

Magnetic Rotational Device

Publication number US20120280588 A1/U.S. application Ser. No. 13/512,086/PCT number PCT/CA2010/001880 Publication date—Nov. 8, 2012/Filing date Nov. 26, 2010 Also published as CA2781694A1, EP2504908A1, WO2011063522A1 Inventors Thomas Patrick Bryson

ROTATIONAL INERTIA AIDED ELECTRIC GENERATOR U.S. Pat. No. 6,914,341 B1—issue date: Jul. 5, 2005—inventor: Stephen mcintyre INERTIA-DRIVEN STANDBY ELECTRIC GENERATOR UNIT U.S. Pat. No. 3,609,426—issue date: Sep. 28, 1971—inventor: Richard Gaul

### FIELD OF THE INVENTION

This Electromagnet SRE—(Self Regenerating Energy Unit) Generator System device derives from a clean energy go green effort towards Alternative Energy. The Electromagnet SRE creates inertial from centrifugal forces by using a dead-weight balanced Spin-Wheel (flywheel) is so configured as to minimize the resistant lag stresses of the generator, cup links an components resistant's. SRE Electromagnets field boxes assembly creates a small magnetic field within an around the coiled wire, projecting out from the SRE Electromagnets.

SRE Electromagnet system's are used by turning the Electromagnet coiled wire on and off by impeding or interrupting the circuit. Magnetic fields are created by the electrified coils stationed within the small

Electromagnets magnetic field by utilizing a secondary energy or by dc batteries Electrical current. Electrical current is introduced to the Electromagnet wiring by either from a battery or another source of electricity.

SRE Electromagnet coiled wire field boxes repel and or attract the spin-wheel magnets which are stationed and positioned securely on or within the spin-wheel itself. You may reverse the position of the SRE Electromagnets Coils and spin-wheel magnets to be stationed or positioned vice-versa in there given places.

### DECRIPTION OF RELATED ART

In today's Inertia machine devices most at best creates only partial energy power support for its own devices. They continue to require external energy support being unable to sustain its own power needs with external needs. However this Electromagnet SRE device that breaks the barriers by not only being self-energy-reliant it also help's supports outside external power needs as well by recharging external deep cell batteries.

This Electromagnet SRE device accomplishes this without using outside external powers or fuel, wind, bio, or solar. This new Electromagnet SRE can be made into a multi-spin-wheel assembly system that generates in access almost 70 percent of its energy to be used for external uses.

### BRIEF SUMMARY OF THE INVENTION

The object here is to provide an on location generator that recharges and stores energy into DC batteries without the use of the wind, solar or any other fuel while in remote locations. To be used by residential homes, land vehicles, water craft, and for any other purpose requiring surplus energy for recharging DC batteries in remote places, or areas. Batteries and SRE Electromagnets initiate the rotation of the unloaded spin-wheels during the startup period and maintain a higher rpm rotation speed output than the generator does even in loaded conditions during the operation.

Unloaded spin-wheels mean that during the start-up period the spin-wheels are not load connected to the weight load of the generator and are each free spinning momentarily by clutch rpm gears on each drive component until each spin-wheel reach a certain rpm speed. It is calculated approximately 30 percent of the energy generated by this single or multi-spin-wheel system will be used internally. This single, or multi spin-wheels, Electromagnets, and centrifugal force of Inertia Dead weight system generates a surplus, excess of energy which will be used for battery energy storage use and may be transformed into other types of current such as AC.

### BRIEF DESCRIPTION VIEWS OF THE DRAWING

A single or multi spin-wheel clutch drive motor system that generates in access almost 70 percent of its energy to be used for external uses. The system operation is sustained by its own inside generator source of energy and batteries. This system item #22—weight spin-wheels, #28—clutch delayed rpm gears, #24—a gear box, or reduction sprockets, #26—the electric generator. #36—several Permanent magnets attached to weight rotating spin-wheels. #40 Electromagnet SRE tower device frame assembly. #34 Each spin-wheel components are equipped with a metal shaft through the middle of it that comprises a clutch delay rpm gear, pulleys, or sprockets.

### The Displacement of Power Transfer

Electromagnet SRE eliminates the resistant dead weight in the multi weighted spin-wheels by using single deep weld ball bearings on a single shaft. Second: by the Electromagnet SRE Spin-Wheel's enhancement of Centrifugal force, high rpm delayed rpm clutches, and the rpm reduction gearing that overpowers the generators resistant. By using the advantage of multi dead weight spin-wheel's the RPM centrifugal force that the clutch delayed rpm gears reduction or gearbox device help utilizes the low amp start up usage. This help increases multiplied torque to enable the use of less than ⅓ of the motor full amp usage when in use and enabling a Electromagnet self-sustaining slow generator power charge.

### How SRE Eliminate the Multi Spin-Wheel Resistants

### Second—How We Eliminate the Generator Resistant's

By Over powering the generators resistant's using 3 lb. to 1 lb. centrifugal force weight compounded through inertia.

### The Clutch Individual Shaft—Multi Spin-Wheel Advantages

1. By utilizing a single or multi weight spin and delayed rpm clutch gears helps Electromagnet SRE use less than 8 start-up amps compared to 68 start-up amps using a all in one weight heavier wheel. 2. The clutch gear advantage method works best by using smaller spin-wheels each on individual drive shaft. 3. The delayed clutch rpm Gears and individual shaft method advantage helps empower the multi-spin-wheels by first rotating only one spin-wheel into centrifugal force using magnets with inertia renders more start-up torque and less drag for the next spin-wheel. 4. A Clutch spin-wheel RPM delay Clutch gear advantage is by using the first smaller spin-wheel of centrifugal force to render less drag and better start-up torque for the next spin-wheels.

### Other Components Used in this Device Machine

Batteries (not shown)=A battery isolator (not shown) is used to split the generators electric output into several directions of output current. The surplus energy goes out into the external output batteries. One or more batteries can be added for the output energy storage depending on the system variation in size and amperage output.

### BRIEF DESCRIPTION OF THE DRAWINGS

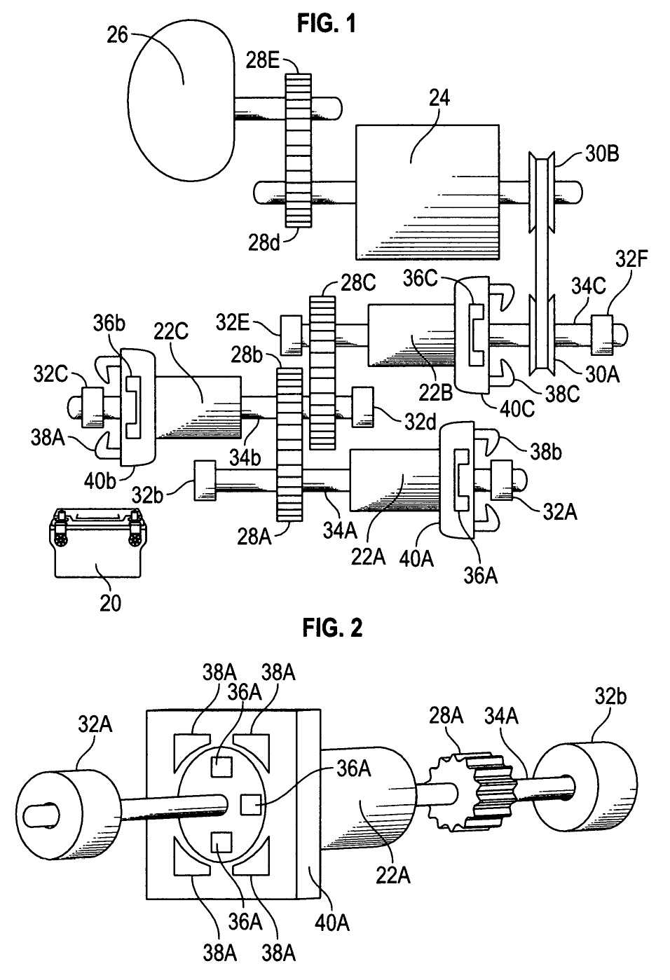

FIG. 1. Is a perspective view of each tower base, spin wheels (fly wheels) union of the embodiment of the SRE device.

FIG. 2, is a perspective face view of one of the SRE spin wheels (fly wheels) devices in FIG. 1.

### DETAILED DESCRIPTION OF THE INVENTION DRAWINGS

FIG. 1, and FIG. 2, Drawing in FIG. 1, is a perspective view of the SRE system of components. FIG. 2, is a perspective plane view of the device in FIG. 1. The system major components among others components includes #20 Battery. 22a, thru 22c Dead-Weight Spin-Wheels that utilizes Centrifugal Force when used at higher rpm speed than the Generator or Alternator. 24 is the gear reduction box, or reduction sprocket, or pulleys in place of gear reduction box. 26 is the turbine generator or alternator est. 28A-thru 28E are high rpm delay drive clutch gears, pulleys, or sprockets. 30a thru 30b are delay clutch gear pulleys, or sprockets. 32A-thru 32F, are deep grove ball barring casings supporting the shaft. 34A, thru 34c are spin-wheel shafts. 36A-36C is several Permanent magnets, or Electrodynamics' superconductive magnet materials in place of the Permanent Magnets which are attached to Dead-Weight spin-wheels. 38A thru 38C are electromagnets which attached to the tower base which attract or repel against the permanent magnets, or Electrodynamics' magnet Materials.

40A-thru 40c, is the tower and tower base in which the electromagnets Magnets are installed on or in, which encloses and surrounds the spin-wheel and its permanent magnets or its Electrodynamics' superconductive magnet material.

Electromagnet SRE plus uses Electromagnets, or superconductive (EDS) magnets, Pulsate dc current on and off Repelling or Attracting the Permanent Magnets or metals that are attached an positioned on the rotating spin-wheels (flywheels) which has a rpm delay clutch gear on each spin-wheel shaft delaying the resistant load until each rotating spin-wheel individually reach a higher rpm of Centrifugal Force of Inertia before engaging clutch gear which an exclusive or privilege is claimed and defined:

1. A Dead Weight Spin-wheel (Flywheel): that utilizes Centrifugal Force of Inertia with a Delay Drive Clutch Gear both centered and rotating on a drive shaft that Electrodynamic (EDS) Superconductive Magnet Materials or Electromagnets Pulses on and off by impeding or interrupting the circuits of the Electromagnets pulse Repelling or Attracting the Permanent Magnets, or metals.
A-1 The device as said in claim 1. A rounded (Flywheel)-Spin-Wheels of Dead-Weight that rotates at a high rpm rotation creating torque by using Centrifugal Force of Inertia.

2. a outer housing base towel that surrounds the spin-wheel (flywheel) with electromagnets or Electrodynamics (EDS) Superconductive magnets Materials installed on or with-in the outer surrounding towel housing casing where several electromagnets, or Electrodynamics (EDS) Superconductive magnets are enclosed within or positioned on the outer housing towel base casing which surrounds the spin-wheel (flywheel) and the permanent magnets.
A-2 The device as said in claim 2. A housing Tower having Electromagnets enclosed on or within the tower surrounding the Spin-Wheel and its Permanent Magnets or metals.

3. The device as claim 3: SRE Electromagnets or Electrodynamics Superconductive mounted magnets are Repelling or Attracting automatically timed by turning the Electromagnet Pulse on and off by interrupting the circuits of the Electromagnets dc current pulse from dc batteries that Repel or Attract Permanent Magnets or metals which are attached to the spinning spin-wheels (flywheels).
